(19) United States
(12) Patent Application Publication
(10) Pub. No.: US 2025/0342108 A1
(43) Pub. Date: Nov. 6, 2025

(54) VALIDATION OF CODE SNIPPETS FROM DOCUMENTATION

(71) Applicant: Red Hat, Inc., Raleigh, NC (US)

(72) Inventors: Leigh Griffin, Waterford (IE); Jaime Lynn Flynn, Austin, TX (US)

(21) Appl. No.: 18/655,643

(22) Filed: May 6, 2024

(51) Int. Cl. G06F 11/36; G06F 8/41

(52) U.S. Cl. CPC G06F 11/3692; G06F 8/433; G06F 8/44; G06F 11/3688; G06F 11/3698

(57) ABSTRACT

A computing system comprising one or more computing devices can access a file comprising documentation that includes a textual description and a source code snippet written to comply with a programming language syntax. The computing system can identify the source code snippet. The computing system can generate an executable based on the source code snippet. The computing system can initiate a test process that accesses the executable, the test process causing the executable to cause an event. The computing system can determine that the event is a valid event or an invalid event.

### BACKGROUND

Software testing is a process for testing whether software meets certain goals or requirements, such as quality requirements or safety requirements. In some instances, software goals or requirements can include requirements defined in whole or in part by government regulation or by a private person or organization, such as an individual or organizational software user, developer, tester, or standard-setting body. Software documentation is documentation for explaining aspects of software packages, libraries, modules, source code, or other code. Software documentation can include developer documentation, which can explain to a software developer how to develop software using the documented code. In some instances, software documentation can include code snippets, such as explanatory example code illustrating how the code can be used in context.

### SUMMARY

Examples provided herein can identify a code snippet in software documentation and implement software testing based on the code snippet. Example tests can automatically determine whether the snippet is syntactically or semantically valid, up to date, compatible with a particular computing environment or aspects thereof, or otherwise meets one or more software requirements (e.g., safety requirements).

In one implementation, a method is provided. The method includes accessing, by a computing system comprising one or more computing devices, a file comprising documentation that includes a textual description and a source code snippet written to comply with a programming language syntax. The method further includes identifying, by the computing system, the source code snippet. The method further includes generating, by the computing system, an executable based on the source code snippet. The method further includes initiating, by the computing system, a test process that accesses the executable, the test process causing the executable to cause an event. The method further includes determining, by the computing system, that the event is a valid event or an invalid event.

In another implementation, a computing system is provided. The computing system includes one or more computing devices. The computing devices are to access a file comprising documentation that includes a textual description and a source code snippet written to comply with a programming language syntax. The computing devices are further to identify the source code snippet. The computing devices are further to generate an executable based on the source code snippet. The computing devices are further to initiate a test process that accesses the executable, the test process causing the executable to cause an event. The computing devices are further to determine that the event is a valid event or an invalid event.

In another implementation, a non-transitory computer-readable storage medium is provided. The non-transitory computer-readable storage medium includes executable instructions to cause a processor device to access a file comprising documentation that includes a textual description and a source code snippet written to comply with a programming language syntax. The instructions further cause the processor device to identify the source code snippet. The instructions further cause the processor device to generate an executable based on the source code snippet. The instructions further cause the processor device to initiate a test process that accesses the executable, the test process causing the executable to cause an event. The instructions further cause the processor device to determine that the event is a valid event or an invalid event.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a computing device suitable for implementing validation of code snippets according to one example.

FIG. 2 is a flow chart diagram of an example method for validating code snippets according to one example.

FIG. 3 is a block diagram of a computing device suitable for implementing validation of code snippets according to one example.

FIG. 4 is a block diagram of a computing device suitable for implementing validation of code snippets according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Software developers and others can sometimes rely on software documentation when developing software. For example, software developers may rely on documentation associated with a software library or package when developing source code that uses the software library or package. Some documentation may contain source code snippets, and software developers may rely on the source code snippets or on text describing the snippets. For example, in some instances, a developer may write code based on a source code snippet (e.g., by copying parts of a code snippet and modifying the copied code), relying on a belief that the code snippet is accurate, up to date, bug free, or operates as described in the documentation.

However, software documentation may not always be reliable. For example, documentation may become stale when code associated with a package or library is updated, but documentation associated with that package or library is not updated. As another example, software documentation may accurately reflect how documented code behaves with respect to some computing environments or use cases, but may be inaccurate with respect to other computing environments or use cases. For example, documented code may be incompatible with certain programming language versions, operating systems, runtime environments, or other aspects of a computing environment. Thus, some software developers may rely on documentation that may not be reliable, which may lead to software bugs or other problems.

Problems associated with relying on unreliable documentation may be particularly severe in the context of safety-sensitive software. For example, automotive software may control or otherwise affect safety-critical devices, such as braking or steering devices. If automotive software is not properly tested, an automotive bug could prevent a safety-critical device from operating properly, possibly leading to severe or life-threatening injury in some instances. Thus, it is important to ensure that inaccuracies associated with stale documentation do not cause software errors that may prevent a safety-critical device from operating properly.

The examples set forth below can automatically validate code snippets associated with software documentation, which can prevent software errors by identifying invalid code or stale documentation before a software developer relies on the documentation. For example, a computing system can identify a code snippet in documentation. The computing system can build an executable based on the code snippet. The computing system can then run tests using the executable to determine whether the code snippet meets various software requirements. If the code snippet does not meet the requirements, then the code snippet or documentation can be flagged as invalid, and developers can avoid using the code snippet or other code associated with the invalid documentation.

In some instances, the software requirements can include general requirements that may be applicable to all or nearly all software. For example, the computing system can test whether a source code snippet is syntactically valid and capable of being compiled. As another example, the computing system can test whether the source code snippet is compatible or incompatible with specific programming language versions, operating systems or operating system versions, compilers, computing environments, or other systems that may interact with the source code snippet.

In some instances, the software requirements can include requirements that are specific to a particular use case, such as a safety-critical software application (e.g., automotive software). For example, a computing system can test source code snippets to automatically determine whether the source code snippet meets specific functional safety requirements, such as freedom from interference requirements and safety integrity level requirements. Example requirements can include functional safety requirements associated with International Organization for Standardization (ISO) standard ISO 26262, which provides functional safety requirements for automotive applications. Some examples set forth below can identify a source code snippet, generate an executable based on the snippet, and perform tests to determine whether software using the code snippet can be safely used in an automotive application in compliance with ISO 26262. In this manner, for instance, safety failures associated with stale documentation can be prevented.

The examples set forth below can provide a variety of technical effects and benefits. For example, some implementations can provide improved technical reliability (e.g., reduced number and severity of software bugs, reduced downtime, fail-safe software operation, etc.) of a computing system. As one example, freedom from interference testing can ensure that a first software instance (e.g., non-safety-critical software in an automotive system) can fail safely, such that a computing device can continue to execute a second software instance (e.g., safety-critical software) in the same computing environment despite a bug, exception, or other failure of the first software instance. In this manner, technical reliability of a computing system (e.g., automotive computing system) can be improved by ensuring that tested software operations cannot interfere with other operations of the computing system. As another example, technical reliability of a computing system can be improved by identifying computing environments or aspects thereof (e.g., programming language versions, operating systems, etc.) that are compatible or incompatible with tested software and ensuring that the computing system executes the tested software in a compatible computing environment. Additionally, some implementations can provide improved safety (e.g., reduced risk of injury or death) of a safety-sensitive computing system (e.g., automotive computing system) by ensuring that operations performed by the computing system meet functional safety requirements (e.g., safety integrity level requirements) and do not interfere with safety-critical operations executing on the same computing system.

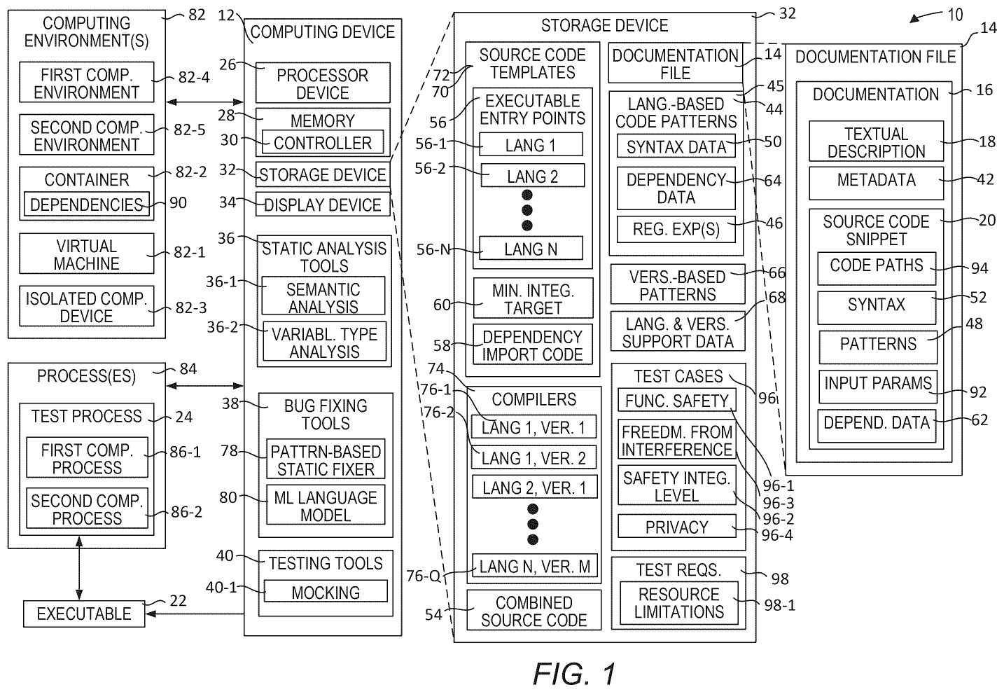

FIG. 1 is a block diagram of a computing system suitable for implementing validation of code snippets according to one example. The computing system 10 may comprise one or more computing devices 12. A computing device 12 can access a documentation file 14 having documentation 16 comprising a textual description 18 and a source code snippet 20. The computing device 12 can identify the source code snippet 20 and generate an executable 22 based on the source code snippet 20. The computing device 12 can execute a test process 24 using the executable 22. The test process 24 can cause an event, and the computing device 12 can determine whether the event is a valid or invalid event.

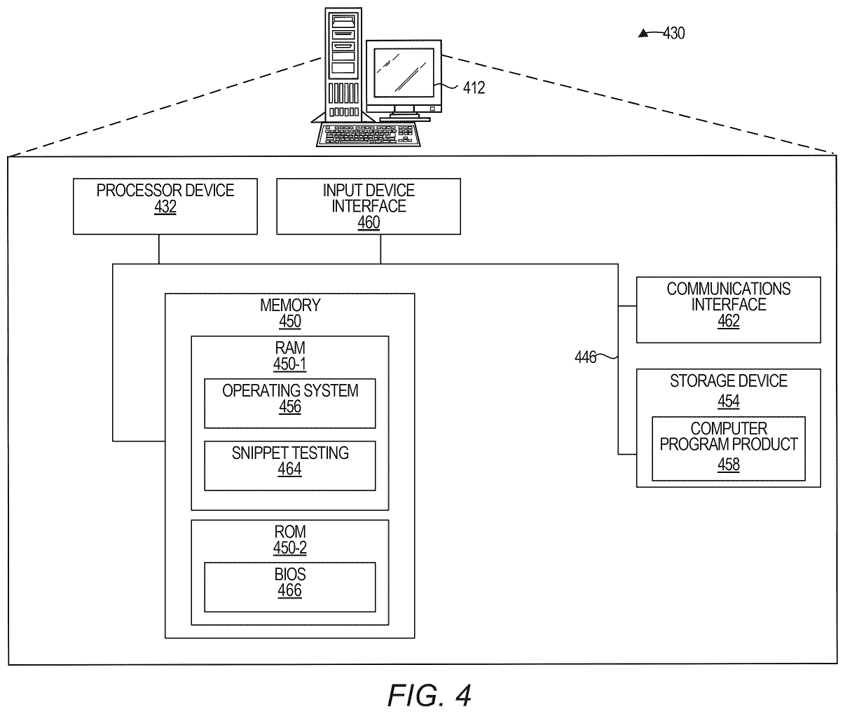

A computing device 12 may comprise any computing or electronic device capable of including firmware, hardware, and/or executing software instructions to implement the functionality described herein, such as a computer server, a desktop computing device, a laptop computing device, a smartphone, a computing tablet, or the like. Each computing device 12 of a computing system 10 can include one or more processor devices 26, memories 28 comprising a memory controller 30, storage devices 32, or display devices 34. In some implementations, a computing device 12 can contain static analysis tools 36, bug fixing tools 38, or testing tools 40. In some implementations, a computing device 12 can include a client device or a server device. Additional example implementation details for a computing device 12 are provided below with respect to FIG. 4.

A documentation file 14 can include, for example, any type of file, such as a text file, word processing document, markup language document (e.g., HTML, XML, JSON, ASCIIDoc, etc.), or any other file to store a textual description 18 and source code snippet 20. The documentation file 14 can include the source code snippet 20 directly (e.g., in a text-based or markup language format), or indirectly (e.g., as a link to another file, internet address, git repository, or other location).

Documentation 16 can include, for example, human-readable data such as textual description 18, source code snippet 20, human-readable metadata 42, and other human-readable data. Documentation 16 can also include, for example, computer-readable data such as computer-readable metadata 42 indicative of a programming language, programming language version, package, library, package or library version, or other property of the source code snippet 20.

In some instances, a documentation file can include human-readable or computer-readable metadata 42. In some instances, the metadata 42 can include markup components (e.g., tags, etc.) associated with a markup language. For example, in some instances, a markup component can include a markup component identifying a source code block, and the source code snippet 20 can be included in a source code block identified by such a markup component. As an illustrative example, a markup language can include an AsciiDoc or AsciiDoctor markup language, and a markup component can include a tag such as “[source, ruby]” and one or more delimiters identifying a beginning and end of a source code block, such as two delimiters comprising four hyphens each (“- - - -”). In some instances, a markup component identifying a source code block can include a markup component referencing a location (e.g., file, internet address, git repository) where text of a source code snippet 20 included in the documentation file 14 may be stored. As an illustrative example, an AsciiDoctor markup component referencing such a storage location can comprise an “include” directive, such as:
[, ruby]
- - - -
include::app.rb [ ]
- - - -
   where ruby is a language in which the included source code was written and app.rb[ ] is a file in which text of the source code snippet 20 included in the documentation 16 is stored. Such an include directive can, for example, load the text of the source code snippet 20 from the app.rb[ ] file when displaying or otherwise rendering the documentation 16 (e.g., for viewing by a user such as a software developer). In this manner, for instance, a source code snippet 20 included in the documentation 16 and the documentation file 14 can include text stored in the documentation file 14 itself, text stored in another location and included or referenced in the documentation file 14, or both.

A textual description 18 can include, for example, any human-readable descriptive or explanatory text that is not source code. As an example, a textual description 18 can include natural language text describing software or source code associated with the source code snippet 20. For example, a textual description 18 may describe, for the benefit of a software developer, what a software package, library, module, or code snippet does; how the package, library, module, or code snippet is to be used; or other information. As another example, a textual description may describe a person or organization that created a software package, library, or module; a version number or other metadata associated with code associated with the source code snippet 20; a description of one or more tests (e.g., methodology, results, date(s) tested, version(s) tested, etc.) that have been performed on a software package, library, module, or code snippet; background information describing related technologies such as related software packages, etc.; or any other explanatory information. As another example, a textual description 18 can include one or more annotations (e.g., code comments, etc.). In some instances, an annotation can include one or more annotation delimiters associated with a language in which a source code snippet 20 was written, wherein the annotation delimiters indicate that the annotation should not be treated as code by a compiler or other software.

A source code snippet 20 can include, for example, one or more source code instructions. In some instances, a source code snippet 20 can include a plurality of source code instructions (e.g., multiple lines of source code, such as two, five, ten, twenty, etc.; source code calling multiple functions, methods, or subroutines; etc.). In some instances, a source code snippet 20 can be a unit of code that is smaller than a standalone software program. For example, in some instances, a source code snippet 20 may lack an executable entry point, such that the source code snippet 20 cannot be compiled into an executable without modification. For example, a source code snippet 20 without an executable entry point may in some instances be uncompilable, or in other instances may be compilable into a library, package, module, binary, or other data structure that is not executable. In some instances, a source code snippet 20 may lack one or more instructions (e.g., instructions for importing dependencies) that may be necessary to run one or more instructions included in the source code snippet. As an illustrative example, a source code snippet 20 may include a source code instruction that calls a function associated with a software package or library but may lack a source code instruction for importing the package or library, which may be necessary to successfully call the function. As an illustrative example, a source code snippet 20 may include an instruction such as np.array ([1, 2, 3]) to call a method associated with the Python package numpy, and the source code snippet 20 may lack an appropriate instruction for importing or otherwise using the numpy package (e.g., import numpy as np).

In some instances, a computing device 12 can identify the source code snippet 20 in the documentation 16. In some instances, identifying the source code snippet 20 can include identifying a markup component indicative of a source code block, and identifying the source code snippet 20 based on the markup component. For example, a computing device 12 can identify a first delimiter indicative of a beginning of the source code block; identify a second delimiter indicative of an end of the source code block; and identify, based on data (e.g., text, markup language, etc.) between the first and second delimiter, the source code snippet 20. A delimiter can include, for example, a markup component (e.g., tag); a character (e.g., comma, semicolon, whitespace character such as newline character, etc.); a context-dependent or context-independent combination of characters (e.g., “- - - -”, “[, ruby]”, etc.); or any other data indicative of a beginning or end of a source code block. Identifying a delimiter can include, for example, searching or parsing a documentation file 14 (e.g., using a regular expression) to identify the delimiter. In some instances, searching or parsing a documentation file 14 can include identifying one or more delimiter strings for delimiting a source code block, and searching or parsing the documentation file 14 based on the one or more delimiter strings. In some instances, identifying a delimiter string can include accessing a data structure correlating a plurality of respective markup languages to a plurality of respective delimiter strings for delimiting a source code block in the respective markup languages. In some instances, identifying a delimiter string can include accessing a data structure correlating a plurality of respective programming languages to a plurality of respective delimiter strings (e.g., regular expressions, etc.) for delimiting a source code block in the respective programming languages.

In some instances, identifying a source code snippet 20 can include identifying the source code snippet 20 based on one or more language-based code patterns 44 (e.g., language keywords, naming conventions, punctuation, etc.) indicative of source code associated with one or more programming languages. In some instances, a language-based code pattern 44 can include a pattern associated with a programming language syntax. For example, some programming languages may use particular characters (e.g., parentheses, curly braces, semicolons, etc.) in ways that are designated by a programming language syntax. In some instances, a pattern associated with a programming language syntax may be unlikely to occur in natural language, in a textual description 18 or metadata 42, or otherwise occur outside of a source code snippet 20. As a non-limiting illustrative example, an open parenthesis character “(” occurring immediately after a non-whitespace character may be rare in natural language but common in source code of some programming languages. Identifying a source code snippet 20 can include, for example, searching or parsing (e.g., using a regular expression 46) a documentation file 14 based on a language-based code pattern 44 to identify a corresponding pattern 48 in the source code snippet 20. In some instances, searching or parsing a documentation file 14 based on a language-based code pattern 44 can include searching or parsing the documentation file based on syntax data 50 to identify source code of the source code snippet 20 that complies with a corresponding syntax 52.

In some instances, a first line of source code can be identified, and identifying a source code snippet 20 can further include, for example, analyzing lines of text before or after the first line to determine whether they are part of the source code snippet 20. For example, identifying a source code snippet 20 can include identifying a programming language in which the first line of source code was written; identifying a line of text occurring before or after the line of source code in the documentation file 14; and determining, based on a comparison between the line of text and syntax data 50 associated with the programming language, whether the line of text is part of the source code snippet 20. In this manner, for instance, a beginning and end of the source code snippet can be identified based on syntax data 50 associated with a programming language of the source code snippet 20 (e.g., after identifying one or more first lines of source code based on a language-based code pattern 44, markup component, delimiter, etc.).

In some instances, a computing device 12 can generate an executable 22 based at least in part on the source code snippet 20.

An executable 22 can include, for example, a file (e.g., application file, .exe file, etc.) comprising one or more computer-readable instructions to be executed by a computing system (e.g., using an operating system). In some instances, an executable 22 can include compiled computer code, such as object code, bytecode, binary code, machine code, etc.

Generating an executable 22 based at least in part on the source code can include, for example, adding additional source code to the source code snippet 20 to generate combined source code 54. In some instances, additional source code can include one or more executable entry points 56 for generating an executable 22 based on a source code snippet 20 that may lack an executable entry point. In some instances, additional source code can include dependency import code 58 for importing a dependency that may be necessary to execute one or more instructions of the source code snippet 20. In some instances, additional code can include source code of one or more functions (e.g., methods, subroutines, etc.) called by the source code snippet 20. In some instances, additional code can include other integration code, such as code associated with a minimal integration target 60, for integrating a source code snippet 20 into an executable 22 (e.g., application, etc.).

In some instances, generating combined source code 54 can include identifying a programming language in which the source code snippet was written, and determining additional code based on the language in which the source code snippet 20 was written.

In some instances, a programming language in which the source code snippet 20 was written can be determined by comparing the source code snippet 20 to one or more language-based code patterns 44 associated with one or more programming languages. For example, determining the programming language in which the source code snippet was written can include accessing a data structure 45 correlating a plurality of respective source code patterns 44 to a plurality of respective programming languages; identifying, in the source code snippet 20, a source code pattern 44 of the plurality of respective source code patterns 44; and determining, based on the identified source code pattern 44 and the data structure 45, the programming language in which the source code snippet 20 was written. For example, identifying a programming language in which the source code snippet 20 was written can include comparing syntax data 50 associated with a plurality of programming languages to a syntax 52 of the source code snippet 20. In such instances, identifying a programming language in which the source code snippet 20 was written can further include determining, for at least one (e.g., exactly one, etc.) programming language of the plurality of programming languages, that a syntax 52 of the source code snippet 20 complies with a syntax of the programming language stored as syntax data 50; and identifying, based at least in part on the determining, that the at least one programming language is a programming language in which the source code snippet 20 was written.

As another example, identifying a programming language in which the source code snippet 20 was written can include comparing dependency data 62 of the source code snippet to dependency data 64 associated with a plurality of programming languages. Dependency data 62 of the source code snippet 20 can include, for example, one or more instructions for importing or including a dependency (e.g., package, library, module, etc.), or one or more instructions that may rely on a dependency. As a non-limiting illustrative example, dependency data 62 of the source code snippet 20 can include an instruction for importing a numpy Python package or an instruction for calling a method associated with the numpy Python package, such as numpy.array( ). Identifying a programming language in which the source code snippet 20 was written based on a comparison between dependency data 62 and dependency data 64 can include, for example, identifying a dependency associated with the source code snippet 20; accessing (e.g., searching, parsing, reading, etc.) a data structure (e.g., dependency data 64) correlating a plurality of respective dependencies to a plurality of respective programming languages; and identifying, based on the data structure and the dependency 62 associated with the source code snippet 20, the programming language in which the source code snippet 20 was written.

In some instances, a programming language in which the source code snippet 20 was written can be determined based on metadata 42 associated with the documentation 16. For example, in some instances, metadata 42 can include data indicative of a programming language associated with the documentation 16 or source code snippet 20. For example, in some instances metadata 42 can include one or more markup components (e.g., AsciiDoctor markup component) identifying a source code block, and the one or more markup components can include data indicative of a language in which the source code was written. As a non-limiting illustrative example, an AsciiDoctor tag such as [source, ruby] or [, ruby] may indicate that a corresponding source code snippet 20 was written in the Ruby programming language. In some instances, identifying a language in which the source code snippet 20 was written can include searching or parsing the documentation file 14 to identify one or more markup components indicative of a source code block; and determining, based on the one or more markup components, a programming language in which the source code snippet 20 was written. In some instances, metadata 42 can include other metadata 42 indicative of a language in which the source code snippet 20 was written, such as a filename or file extension associated with the documentation file 14, a file containing text of the source code snippet 20 (e.g., referenced by a markup component such as an AsciiDoctor “include” tag, etc.), or other file. In some instances, identifying a language in which a source code snippet 20 was written can include identifying a file extension of a file associated with the source code snippet 20 and identifying, based on the file extension, a programming language in which the source code snippet 20 was written. In some instances, metadata 42 indicative of a language in which the source code snippet 20 was written can include source code examples other than the source code snippet (e.g., header code, import statements, etc.). In some instances, a textual description 18 can include an indication (e.g., in natural language) of a programming language in which the source code was written. In some instances, identifying a programming language in which the source code was written can include searching or parsing a textual description 18 based on a plurality of programming language names (e.g., Java, C#, Rust, etc.).

In some instances, identifying a programming language in which the source code snippet 20 was written can be based at least in part on one or more regular expressions 46. For example, a computing device 12 can access a data structure comprising a plurality of respective regular expressions 46 indicative of a plurality of respective code patterns 44 associated respectively with a plurality of respective programming languages; identify, based on one or more regular expressions 46, a pattern 48 contained in the source code snippet 20; and determining, based on the identified pattern 48 and the data structure, a programming language in which the source code snippet 20 was written.

In some instances, a computing device 12 can also identify a version (e.g., programming language version, runtime environment version, etc.) associated with the source code snippet 20. For example, a computing device 12 may access a data structure 66 correlating a plurality of respective version-based patterns to a plurality of respective programming language versions; compare one or more of the version-based patterns to the source code snippet 20, metadata 42, or other component of the documentation file 14; and determine, based on the comparison, a version associated with the source code snippet 20. In some instances, the computing device 12 can identify a programming language in which the source code snippet 20 was written; retrieve, based on the programming language from the data structure 66, a plurality of version-based patterns associated with the programming language; and compare the retrieved patterns to the documentation file 14.

In some instances, a computing device 12 can compare an identified programming language or identified version to language and version support data 68. For example, in some instances, language and version support data 68 may indicate that a particular programming language or version is not supported, and the computing system 10 can output a message indicating that the source code snippet 20 should not be used. Example instances in which a language or version may not be supported include instances when the language or version may have an unpatched vulnerability that is incompatible with one or more software requirements (e.g., functional safety requirements, etc.) of a software system; instances in which a language or version has not been tested according to a mandatory testing protocol; and other circumstances in which an alternate language or version may be preferred over the unsupported language or version.

Generating an executable 22 can further include, for example, determining additional source code based on the identified programming language; and adding the additional source code to the source code snippet 20 to generate combined source code 54. Determining additional source code can include, for example, accessing a data structure 70 correlating a plurality of predetermined source code templates 72 to a plurality of programming languages; and identifying, based on the data structure, a predetermined source code template 72 of the plurality of predetermined source code templates 72, the predetermined source code template 72 being associated with the programming language in which the source code snippet 20 was written. Predetermined source code templates 72 can include, for example, source code templates comprising executable entry points 56, dependency import code 58, minimal integration targets 60, or other additional code. Executable entry points 56 can include, for example, one or more source code instructions (e.g. public static void Main (string [ ] args), etc.) defining a place in an executable 22 where execution of the executable 22 begins. Minimal integration targets 60 can include, for example, one or more source code instructions or source code file components that may be necessary for integrating a non-executable file (e.g., header file, package, library, module, etc.) comprising the source code snippet 20 with an executable 22.

Dependency import code 58 can include, for example, one or more source code instructions for importing or including a dependency associated with the source code snippet 20. In some instances, determining additional source code can include comparing dependency data 64 to dependency data 62; identifying, based on the comparison, a dependency associated with the source code snippet 20; and retrieving, from a data structure comprising dependency import code 58, dependency import code associated with the identified dependency.

In some instances, additional code can include source code of one or more functions (e.g., methods, subroutines, etc.) called by the source code snippet 20. Identifying source code of a function called by the source code snippet 20 can include, for example, identifying a file in which the source code of the function is stored (e.g., based on metadata 42, based on a pattern 48 associated with the source code snippet 20, based on pattern matching using a regular expression, etc.). Determining additional source code to add to the source code snippet 20 can further include, for example, retrieving the additional source code from the file (e.g., based on a syntax of a programming language in which the source code snippet was written, based on pattern matching, based on a name of the function, etc.).

Generating an executable 22 can further include, for example, identifying, based at least in part on a programming language in which the source code snippet 20 was written, a compiler for compiling the combined source code 54 or the source code snippet 20 into an executable 22. Generating an executable 22 can further include causing the combined source code 54 or the source code snippet 20 to be compiled using the identified compiler. Identifying a compiler can include accessing a data structure 74 correlating a plurality of programming languages to a plurality of compilers 76-1 to 76-Q for compiling source code 20, 54 written in the programming language; and retrieving, from the data structure, a compiler associated with the programming language in which the source code snippet 20 was written.

In some instances, a compiler can be determined based at least in part on a programming language version associated with the source code snippet 20. For example, a data structure 74 can correlate a plurality of compilers 76-1 to 76-Q to a plurality of programming language versions, and identifying a compiler can include accessing the data structure 74 and retrieving, based on a programming language version associated with the source code snippet, a compiler to compile the programming language version.

In some instances, generating an executable 22 can include performing code correction, either before or after adding additional code to generate combined source code 54. For example, a computing system 10 can identify, based on a comparison between syntax data 50 and syntax 52 of the source code snippet 20, a syntax error in the source code snippet 20. In some instances, the computing system 10 can determine a correction for the syntax error and modify the source code snippet 20 based on the correction (e.g., before or after adding additional code to generate combined source code 54 comprising the source code snippet 20).

In some instances, determining a correction for a syntax error can include pattern-based static analysis. For example, a pattern-based static bug fixer 78 can identify an error (e.g., bug, syntax error, etc.) associated with the source code snippet 20; determine, based on the error, one or more edits to the source code snippet 20; and apply the one or more edits to the source code snippet 20 to generate corrected source code. In some instances, an edit can be determined via static analysis of the source code snippet 20. For example, determining an edit can include comparing the source code snippet 20 to syntax data 50 of a programming language in which the source code snippet 20 was written (e.g., using a regular expression 46, etc.). Determining an edit can further include determining, based on the comparison, one or more ways in which the source code snippet 20 does not comply with a syntax of the programming language in which the source code snippet 20 was written. Determining an edit can further include determining, based on a way in which the source code snippet 20 does not comply with the syntax, an edit to correct the non-compliance.

In some instances, an edit can be determined based at least in part on data indicative of a type of bug, such as an error code, exception name, or other data. In some instances, an edit can be determined based at least in part on data received from one or more language-based software tools associated with the programming language in which the source code snippet 20 was written, such as a compiler 76-1 to 76-Q. For example, a computing system 10 may attempt to compile combined source code 54 using a compiler 76-1 to 76-Q. The compiler 76-1 to 76-Q can return data indicative of a compilation error, such as a syntax error that may prevent the combined source code 54 from being compiled. The data may include, for example, an error message or error code; a line number or other data identifying a source code instruction responsible for the error; and other data. A static bug fixer 78 can identify, based on data indicative of an error type (e.g., error message or error code), an edit template. The static bug fixer 78 can identify, based on data from a a compiler 76-1 to 76-Q, a source code instruction to edit. Performing an edit can include applying the edit template to the source code instruction. An edit template can include, for example, one or more computer-readable instructions to add one or more characters or tokens; delete one or more characters or tokens; edit or replace one or more characters or tokens; or any combination thereof. In some instances, an edit template can include one or more conditional instructions or branching instructions (e.g., if/then/else, etc.). As an example, a compiler 76-1 to 76-Q could return error data associated with a syntax error wherein an end-of-line error is unexpectedly encountered. A static bug fixer 78 can access a data structure correlating syntax errors of a language in which the source code snippet 20 was written to one or more edit templates for correcting the errors. The static bug fixer 78 can retrieve an edit template from the data structure, which may include, for example, instructions for adding one or more missing characters (e.g., semicolons; paired punctuation marks such as closing parentheses, brackets, or quotation marks; etc.), or instructions for determining, based on static code analysis, whether such characters are missing. The static bug fixer 78 can then apply the edit template to the entire source code snippet 20, or to a particular source code instruction (e.g., identified by a compiler 76-1 to 76-Q), to generate corrected source code.

In some instances, determining a correction for a syntax error or other bug can include machine-learned code correction. For example, an input context associated with the syntax error or other bug can be provided to a machine-learned language model 80, and the machine-learned language model 80 can generate corrected code based on the context. In some instances, input context can include the source code snippet 20 or one or more source code instructions thereof. In some instances, input context can include data indicative of a particular bug, such as an error message, error code, line number, or other data from a compiler 76-1 to 76-Q. In some instances, an input context can include a prompt (e.g., chain-of-thought prompt, few-shot prompt, etc.) instructing the machine-learned language model 80 to correct the error. In some instances, an input context can include language-specific data associated with a programming language in which the source code snippet 20 was written. For example, an input context can include data (e.g., structured data, computer-readable data, human-readable natural language explanation, etc.) indicative of likely causes of or likely solutions to a particular error type associated with the programming language. In some instances, the machine-learned language model 80 can be a language model that was trained (e.g., pretrained, fine-tuned, etc.) for code generation. In some instances, the machine-learned language model 80 can be a language model that was trained based on the programming language in which the source code snippet 20 was written (e.g., single-language model; multi-language model; foundation model fine-tuned on the programming language in which the source code was written; etc.).

In some instances, identifying a bug can include semantic analysis. For example, a pattern-based static bug fixer 78 can identify one or more variable names in the source code snippet 20 (e.g., based on language-based code patterns 44, etc.) and can determine whether the one or more variable names have been properly declared, initialized, defined, or otherwise properly used by the source code snippet 20. As an illustrative example, if a variable name contains a typographical error, a pattern-based static bug fixer 78 may determine that a first variable having a first variable name is initialized but never used, and that a second variable having a second variable name is used but never initialized. In some instances, the pattern-based static bug fixer 78 may correct such a typographical error (e.g., by replacing the second variable name with the first variable name). In some instances, a machine-learned language model 80 can be prompted with an input context associated with the source code snippet 20, and the machine-learned language model 80 can generate corrected code to correct a semantic error. Input context can include, for example, source code; one or more prompts (e.g., few-shot prompts, etc.) containing instructions for correcting a semantic error; data indicative of a semantic error (e.g., identified by static analysis tools 36 or static bug fixer 78, etc.); or other input context.

After generating an executable 22, a computing system 10 can initiate one or more test processes 24 using the executable. Initiating a test process 24 can include, for example, initiating a computing environment 82. Initiating a test process 24 can further include, for example, initiating a process 84 comprising the executable 22 in the initiated computing environment 82.

In some instances, a computing environment 82 to run a test process 24 can include a virtual computing environment, such as a virtual machine 82-1 or container 82-2. In some instances, a computing environment 82 to run a test process 24 can include an isolated computing environment (e.g., testing environment isolated from a production environment, secure environment, etc.), such as a container 82-2, virtual machine 82-1, or isolated computing device 82-3. In some instances, initiating a test process 24 can include initiating a plurality of computing environments 82 and/or a plurality of processes 86-1, 86-2. For example, a test process can include a first computing process 86-1 comprising the executable 22, and a second computing process 86-2 running in a computing environment 82 that is the same as or different from a computing environment 82 of the first computing process 86-1. In some instances, a computing environment 82 can include one or more dependencies 90 associated with the source code snippet 20. For example, initiating a computing environment can include determining, based on dependency data 62 associated with the source code snippet 20, a dependency 90 needed to run an executable 22; and initiating, based on the determination, a computing environment 82 having the dependency 90. In some instances, the computing environment 82 can include a container 82-2. In some instances, generating a container having a particular dependency 90 can include obtaining (e.g., generating; receiving from another computing device; retrieving, such as from a git repository; etc.) a container build file or container image having the dependency 90. In some instances, obtaining a container image can include building the container image from a container build file having the dependency 90. In some instances, generating a container 82-2 having the dependency 90 can further include initiating a container 82-2 based on the container image having the dependency 90.

In some instances, initiating a test process 24 can include generating one or more inputs based on one or more input parameters 92 of the source code snippet 20. For example, an input mocking tool 40-1 can generate mock inputs based at least in part on the source code snippet 20. In some instances, generating mock inputs can include identifying a variable type (e.g., integer, floating-point, string, etc.) associated with the input parameter 92; generating a mock input having the variable type; and providing the mock input as an input. In some instances, the mock input can include a random value associated with the variable type; a default value associated with the variable type; or other value. In some instances, a mocking tool 40-1 can analyze code or documentation associated with the code snippet 20 and generate a mock input based on the analysis. For example, a mocking tool 40-1 can identify related code called by a source code snippet 20 or from which a source code snippet 20 is likely to receive one or more inputs. The mocking tool 40-1 can analyze the related code to determine or estimate one or more properties of the related code's outputs (e.g., variable types; statistical data such as mean and median values, mean and median variable length or size, standard deviations or other variance-related metrics, etc.; purpose or function of the outputs or related code; etc.). In some instances, a mocking tool 40-1 can include a machine-learned language model, and the mocking tool 40-1 can generate mock inputs based on documentation of the source code snippet 20 or related code (e.g., based on textual description 18 describing a purpose, function, statistical property, or other information associated with an input parameter 92). In some instances, a mocking tool 40-1 can provide mock inputs in the combined source code 54 (e.g., before compiling the executable 22), or in the test process 24 (e.g., after compiling the executable 22). In some instances, a mocking tool 40-1 can generate a mock second process 86-2 to provide an interface for an executable 22 to request and receive mock inputs.

In some instances, generating mock inputs can include generating a plurality of mock inputs associated with a plurality of code paths 94. A code path 94 can include, for example, a subset of instructions that an executable 22 or process 86-1, 86-2 may follow under some circumstances (e.g., responsive to some input parameters, etc.) but not all circumstances. As an illustrative example, a source code snippet 20 having a conditional statement (e.g., if/then/else statement, case statement, conditional evaluation associated with a loop, etc.) is likely to have two or more code paths. For example, a first code path 94 may be followed if a condition associated with the conditional statement is met, and a second, different code path may be followed if the condition is not met. A mocking tool 40-1 can identify, for example, a plurality of code paths 94 associated with the source code snippet 20 and generate, for each code path 94 of the plurality of code paths 94, one or more inputs. In some instances, the one or more inputs can include an input to cause the source code snippet 20 to follow the code path 94. For example, a computing system 10 can initiate a plurality of respective test processes, wherein each respective test process causes the executable to follow a respective code path and to cause a respective event; and determine whether each respective event is a valid or invalid event. In some instances, the one or more inputs can include an input or variable to be received or used by an executable 22 when following the code path 94.

In some instances, a computing device 12 can select one or more parameters of a test process 24 based on a programming language or version associated with the source code snippet 20. For example, the computing device 12 can identify a programming language and version associated with the source code snippet 20; access a data structure comprising language and version support data 68; and determine, based on the data structure, one or more parameters of the test process 24. Example test process 24 parameters can include, for instance, logging parameters, debugging parameters, or other test process parameters that may be supported in some versions and unsupported in other versions. For example, the computing device 12 can determine, based on language and version support data 68, that a preferred debugging option is supported by a version associated with the source code snippet 20; and initiate, responsive to the determination, a test process including the preferred debugging option. In some instances, a computing device 12 can determine an example process 86-1, 86-2 to include in the test process 24 based on a version associated with the source code snippet 20. For example, a computing device 12 can determine, based on language and version support data 68, that a debugging process can be attached to processes 86-1, 86-2 associated with a programming language version associated with the source code snippet 20. Responsive to that determination, the computing device 12 can initiate a test process 24 comprising a first process 86-1 running an executable 22, and a second process 86-2 running the debugging process, wherein the debugging process is attached to the first process 86-1.

In some instances, initiating a test process 24 can include initiating a process 84 based on one or more test cases. In some instances, a test case can include a freedom from interference test case. In some examples, a test process 24 associated with a freedom from interference test case 96 can include initiating a first computing process 86-1 comprising an executable 22 associated with the source code snippet 20; initiating a second computing process 86-2; causing the first computing process 86-1 to encounter an error (e.g., stack overflow, divide by zero, null pointer, variable type mismatch, etc.); and determining whether the error interferes with the second process 86-2. In some instances, an example second computing process 86-2 can include a safety-critical or safety-sensitive computing process, such as a computing process to control all or part of a hazardous device (e.g., automobile, etc.), a computing process associated with a safety-sensitive function (e.g., fire prevention, etc.), a computing process associated with a safety integrity level (e.g., automotive safety integrity level, etc.), or a computing process subject to safety-related regulations, standards, requirements, goals, or other safety objectives. In some instances, the first computing process 86-1 and second computing process 86-2 can be initiated in the same computing environment 82 or in different computing environments 82. In some instances, a first computing environment 82-4 for running a first computing process 86-1 can include a container. In some instances, a second computing environment 82-5 for running a second computing process 86-1 can include a container. In some instances, a first computing environment 82-4 and second computing environment 82-5 can be initiated on the same computing device (e.g., two containers on a single computing device; two virtual machines on a single computing device; etc.).

In some instances, causing the first computing process 86-1 to encounter an error can include providing a mock input to cause the error. In some instances, providing a mock input to cause an error can include identifying one or more valid variable types associated with an input parameter 92 of the source code, and generating a mock input that does not correspond to a valid variable type (e.g., null input, input having a different variable type, etc.). For example, providing a mock input to cause an error can include determining an invalid input value for an input parameter; and providing the invalid input value as input. In some instances, providing a mock input to cause an error can include analyzing the source code snippet 20 and determining, based on the analysis, a mock input to cause an error (e.g., recursive input or very large input to cause a stack overflow error; numerical input such as zero to cause a divide by zero error; etc.).

In some instances, causing the first computing process 86-1 to encounter an error can include initiating the first computing process 86-1 in a computing environment 82 in which an error will occur. For example, causing an error can include identifying, based at least in part on the source code snippet, a dependency associated with the executable 22; providing a computing environment 82 that lacks the dependency; and initiating a test process 24 comprising the executable 22 in the computing environment 82 lacking the dependency.

In some instances, determining whether an error in the first computing process 86-1 has caused interference with the second computing process 86-2 can include analyzing a performance (e.g., speed, output quality, etc.) of the second computing process 86-2. For example, determining whether interference has occurred can include generating, using the second computing process 86-2, one or more first outputs (e.g., based on inputs, etc.); comparing the first outputs to second outputs generated in the absence of an error (e.g., when the first computing process 86-1 is not running; when the first computing process 86-1 runs without error; etc.); and determining, based on the comparison, whether the first outputs are valid outputs. An output can include, for example, a control signal to control a device (e.g., automotive component, etc.); one or more computer-readable values (e.g., strings, integers, etc.); or any other output. As another example, determining whether interference has occurred can include performing, using the second computing process 86-2, one or more first actions (e.g., responsive to inputs or events, etc.); comparing the first actions to second actions performed in the absence of an error (e.g., when the first computing process 86-1 is not running; when the first computing process 86-1 runs without error; etc.); and determining, based on the comparison, whether the first actions are valid actions. As another example, determining whether interference has occurred can include performing, using the second computing process 86-2, one or more first actions (e.g., responsive to inputs or events, etc.); comparing a time taken to perform the first actions to a time taken to perform second actions in the absence of an error (e.g., when the first computing process 86-1 is not running; when the first computing process 86-1 runs without error; etc.); and determining, based on the comparison, whether the time taken to perform the first actions is acceptable.

In some instances, determining whether interference has occurred can include determining whether a second process 86-2 continues operating (e.g., indefinitely, until completion of a task, etc.) after the error occurs in a first process 86-1 comprising an executable 22 associated with a source code snippet 20. In some instances, determining whether interference has occurred can include determining whether a second process handles errors appropriately or otherwise fails gracefully. For example, in some instances, a non-safety-critical process (e.g., associated with an executable 22) can provide an invalid input to a safety-critical process (e.g., process subject to a safety integrity level requirement, etc.). In some instances, a safety-critical process can be designed or required to account for such errors by validating received inputs before using the received inputs. In such instances, determining whether an invalid input has interfered with the safety-critical process can include determining whether the safety-critical process has properly handled the invalid input according to one or more requirements (e.g., safety integrity level requirements, etc.).

In some instances, determining whether interference has occurred can include running one or more test cases 96 (e.g., functional safety test cases 96-1, safety integrity level test cases 96-2, etc.) associated with the second process 86-2. Determining whether interference has occurred can include determining that the second process 86-2 has passed one or more test cases; and determining, based on the passed test cases, that interference has not occurred. Determining whether interference has occurred can include determining that the second process 86-2 has failed one or more test cases; and determining, based on the failure, that interference has occurred. In some instances, determining whether a test case has been passed can include comparing an output generated during the test to an expected or desired output; comparing a performance (e.g., throughput, latency, processor usage, memory usage, electricity usage, etc.) of the second process 86-2 during the test to an expected or desired performance; or comparing an aspect of the second process 86-2 to a test requirement 98 or expected value associated with a test case 96.

In some instances, determining whether interference has occurred can include determining whether a first process 86-1 has complied with one or more resource limitations 98-1. A resource limitation 98-1 can include, for example, a resource limitation 98-1 defined by one or more resource management settings of an operating system associated with a computing environment 82, such as a Linux control group (cgroup) associated with the Linux operating system. For example, a resource management setting defining a resource limitation 98-1 can include a plurality of hierarchically ordered groups of computing processes 84, with rules for allocating, prioritizing, denying, managing, and monitoring system resources associated with the groups of processes. A resource limitation 98-1 can include limitations on usage of any resource associated with a computing environment 82 (e.g., processor resources, memory or storage resources, input/output resources, etc.). A resource limitation 98-1 can include, for example, a resource availability requirement, such as a requirement defining a minimum amount of a resource that must be made available to a second computing process 86-2, such as a second computing process 86-2 associated with a high-priority process group or safety-sensitive process.

In some instances, a test process 24 can be initiated based on a functional safety test case 96-1, safety integrity level test case 96-2 (e.g., automotive safety integrity level test case, etc.), freedom from interference test case 96-3, or privacy or data security test case 96-4 (e.g., based on data privacy laws such as Europe's General Data Protection Regulation, etc.). In some instances, a computing device 12 can select one or more test cases 96 based on a textual description 18 or metadata 42, such as headers of the documentation 16 or documentation file 14. For example, a textual description 18 or metadata 42 can in some instances describe a system or component (e.g. automotive braking system, etc.) that the source code snippet 20 is designed to be used with, or other context associated with the source code snippet 20. In such instances, selecting one or more test cases 96 can include accessing a data structure correlating a plurality of respective test cases 96 with a plurality of respective contexts in which the test cases are applicable; and retrieving, from the data structure based on a context associated with the source code snippet 20, one or more applicable test cases 96.

In some instances, one or more test cases 96 can be selected based on metadata 42, textual description 18, or other data identifying test cases 96 to be performed for a source code snippet 20. For example, documentation 16 may include data (e.g., textual description 18, metadata 42, etc.) indicating that an earlier version of the source code snippet 20 has passed certain test cases 96 in the past. As another example, documentation 16 may include data (e.g., textual description 18, metadata 42, etc.) asserting that the source code snippet 20 has certain properties (e.g., security properties, safety properties, compatibility properties, input types, output types, etc.) or had certain properties at the time the documentation 16 was created. In some instances, a test case 96 that the source code snippet 20 has passed can include a custom test case associated with the source code snippet 20. In some instances, a custom test case 96 can include a test case 96 written based at least in part on the source code snippet 20 or written based at least in part on requirements (e.g., functional safety requirements, safety integrity level requirements, etc.) associated with the source code snippet 20. In some instances, the metadata 42 or textual description 18 may include data indicative of a date on which one or more test cases 96 were passed or a date on which one or more asserted properties of the source code snippet 20 were tested. Similarly, the metadata 42 or textual description 18 may include source code version data, documentation version data, or other data indicative of a currentness of testing that has been performed (e.g., test cases 96, properties tested, etc.). In some instances, selecting a test case 96 to execute can include identifying (e.g., based on metadata 42) one or more test cases 96 associated with one or more prior tests of the source code snippet 20; determining, based on data indicative of a currentness of testing performed on the source code snippet 20, that at least one of the one or more prior tests is not current; and selecting, based on the at least one prior test, one or more test cases 96 to execute.

In some instances, a test process 24 can be initiated based on a safety integrity level test case 96-2. In some instances, a computing device 12 can select one or more safety integrity level test cases 96-2 by obtaining one or more safety integrity levels associated with the source code snippet 20 or associated with a context associated with the source code snippet 20 (e.g. associated system or component associated with the source code snippet 20, related code associated with the source code snippet 20, related computing process 86-2 expected to be performed on a same computing device with the source code snippet, etc.); and retrieving, from a data structure correlating safety integrity levels with safety integrity level test cases 96-2, one or more safety integrity level test cases 96-2 to be performed. In some instances, obtaining a safety integrity level can include receiving data indicative of a safety integrity level (e.g., from a client, software developer, automotive manufacturer, etc.), determining a safety integrity level based on a safety integrity level of related code, or determining a safety integrity level based on a risk assessment assessing a risk of injury (e.g., likelihood of injury, severity of injury, etc.) in the event of a failure of a system or component associated with a source code snippet 20. A safety integrity level test case 96-2 can include, for example, one or more actions to be performed (e.g., computing processes 86-1, 86-2 to be initiated, etc.), one or more requirements to be met, or other test case data. In some instances, a safety integrity level test case 96-2 can include, for example, one or more prohibited actions that must not be performed, and determining whether a test has been validly passed can include determining whether a prohibited action has been or can be performed. In some instances, a safety integrity level test cases 96-2 can include, for example, one or more required actions that either must be performed or must be capable of being performed, and determining whether a test has been validly passed can include determining whether a required action has been or can be performed.

In some instances, a computing device 12 can use static analysis tools 36 to perform static analysis of a source code snippet 20 (e.g., alone or in context with related code). For example, in some instances, requirements associated with a safety integrity level may require that code associated with the integrity level does not call a function that has not been tested, preapproved, or otherwise determined to be valid. In such instances, a semantic analysis tool 36-1 can identify one or more functions called by a source code snippet 20 and determine whether the function can be validly called according to one or more safety integrity level requirements. For example, the semantic analysis tool 36-1 can identify a package, library, application programming interface (API), or other body of code that the function belongs to; compare the body of code to a data structure identifying bodies of code (e.g., APIs, etc.) that have been determined to be valid; and determine, based on the comparison, whether the function can be validly called according to one or more safety integrity levels. In some instances, a body of code may be valid for use in the context of a lower safety integrity level (e.g., low, medium, etc.) and may be invalid for use with a higher safety integrity level.

As another example, a variable type analysis tool 36-2 can identify, based on a comparison between one or more first variable types and one or more second variable types, one or more potential type mismatch errors. For example, a variable type analysis tool 36-2 can compare a return type of one or more functions called by a source code snippet 20 to a variable type of a corresponding variable or parameter that may be initialized or updated based on a return of the one or more functions. For example, a variable type analysis tool 36-2 can compare one or more variable definitions (e.g., type definitions, variable declarations, variable initializations, method signature lines comprising method parameter declarations, etc.) to one or more return types. As another example, a variable type analysis tool 36-2 can compare a variable type of one or more input parameters (e.g., input parameters of a function to be called) to a corresponding variable type of one or more variable definitions (e.g., type definitions, variable declarations, variable initializations, etc.). If the variable type analysis tool 36-2 determines that a variable type mismatch is possible (e.g., due to weakly typed variables) or probable (e.g., due to a mismatch between expressly declared variable types), the variable type analysis tool 36-2 can determine that the code being analyzed is invalid according to one or more safety integrity levels. For example, the variable type analysis tool 36-2 can determine that one or more variable types of the source code snippet 20 are valid or invalid based on a comparison between a potential type mismatch and one or more variable typing requirements associated with a safety integrity level.

In some instances, a test process 24 can cause the executable 22 to cause an event. An event can include, for example, an output (e.g., control signal, output value, etc.), an action performed by a computing device (e.g., processor action, memory action, input/output action, etc.), a performance of a computing process (e.g., latency, bandwidth, execution time, processor usage, memory usage, other resource usage, etc.), or other event. In some instances, a computing device 12 can determine whether an event is a valid or invalid event. An event can be valid, for example, if it complies with one or more requirements (e.g., resource limitations, non-interference limitations, safety integrity level requirements, requirements associated with a test case 96, etc.), matches an expected or desired event (e.g., expected or desired output value, etc.), exceeds a validity threshold (e.g., performance threshold, etc.), or otherwise is valid with respect to a test case 96 or test process 24. An event can be invalid, for example, if it does not meet one or more validity criteria (e.g., as described in the previous sentence).

In some instances, if a test causes an invalid event, a computing device 12 can perform one or more remediation actions. In some instances, a remediation action can include notifying an individual or organizational user (e.g., software developer, etc.) of the invalid event. In some instances, a remediation action can include automated code correction. For example, in instances where a code path 94 fails a freedom from interference test due to an uncaught exception, automated code correction can include inserting, in the code path 94, one or more source code instructions for catching an exception. As another example, in instances where a test failure is associated with a variable type mismatch error, automated code correction can include inserting type definition code, type checking code, or strict typing flags to automatically enforce stricter variable typing. As another example, automated code correction can include generating, using a machine-learned language model 80, candidate corrected code; testing, using methods described above, the candidate corrected code; and accepting, responsive to the candidate corrected code passing one or more applicable tests, the candidate corrected code as final corrected code. In some instances, a source code snippet 20 can be automatically updated with corrected code, or corrected code can be provided to a user (e.g., software developer, documentation author, etc.) for approval before updating the source code snippet 20. In some instances, a remediation action can include providing one or more remediation recommendations (e.g., candidate corrected code, natural language description of a proposed correction process, etc.) to a user (e.g., software developer, etc.).

A processor device 26, memory 28, memory controller 30, storage device 32, or display device 34 can in some implementations be standard components constructed according to known methods. Additional example implementation details for an example processor device 26, memory 28, memory controller 30, storage device 32, or display device 34 are provided below with respect to FIG. 4.

Because the static analysis tools 36, bug fixing tools 38, and testing tools 40 are components of the computing device 12, functionality implemented by the static analysis tools 36, bug fixing tools 38, or testing tools 40 may be attributed to the computing device 12 generally. Moreover, in examples where the static analysis tools 36, bug fixing tools 38, or testing tools 40 comprise software instructions that program the processor device 26 to carry out functionality discussed herein, functionality implemented by the static analysis tools 36, bug fixing tools 38, or testing tools 40 may be attributed herein to the processor device 26.

It is further noted that while the static analysis tools 36, bug fixing tools 38, testing tools 40, and components thereof are shown as separate components, in other implementations, the static analysis tools 36, bug fixing tools 38, and testing tools 40 could be implemented in a single component or could be implemented in a number of components greater than or less than the number depicted.

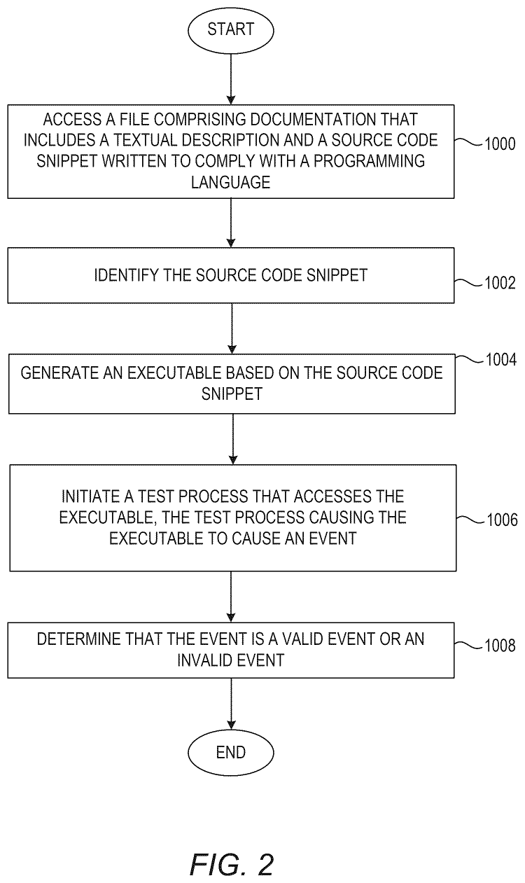

FIG. 2 is a flow chart diagram of an example method for validating code snippets according to one example. The method of FIG. 2 can be performed, for example, by a computing system 10.

At 1000, a computing system 10 can access a file (e.g., documentation file 14) comprising documentation (e.g., documentation 16) that includes a textual description (e.g., textual description 18) and a source code snippet (e.g., source code snippet 20) written to comply with a programming language. The file can be stored, for example, on the computing system 10 (e.g., on a storage device 32) or on another computing system or device (e.g., connected to computing system 10 over a network). Accessing can include, for example, retrieving (e.g., from memory), receiving (e.g., over a network), opening, reading, parsing, copying, searching, and the like.

At 1002, a computing system 10 can identify the source code snippet. Identifying the source code snippet can include, for example, performing one or more actions described above with respect to FIG. 1.

At 1004, the computing system 10 can generate an executable (e.g., executable 22) based on the source code snippet. Generating the executable can include, for example, performing one or more actions described above with respect to FIG. 1.

At 1006, the computing system 10 can initiate a test process (e.g., test process 24) that accesses the executable, the test process causing the executable to cause an event. Initiating the test process can include, for example, performing one or more actions described above with respect to FIG. 1.

At 1008, the computing system 10 can determine that the event is a valid event or an invalid event. Determining that the event is a valid event or an invalid event can include, for example, performing one or more actions described above with respect to FIG. 1.

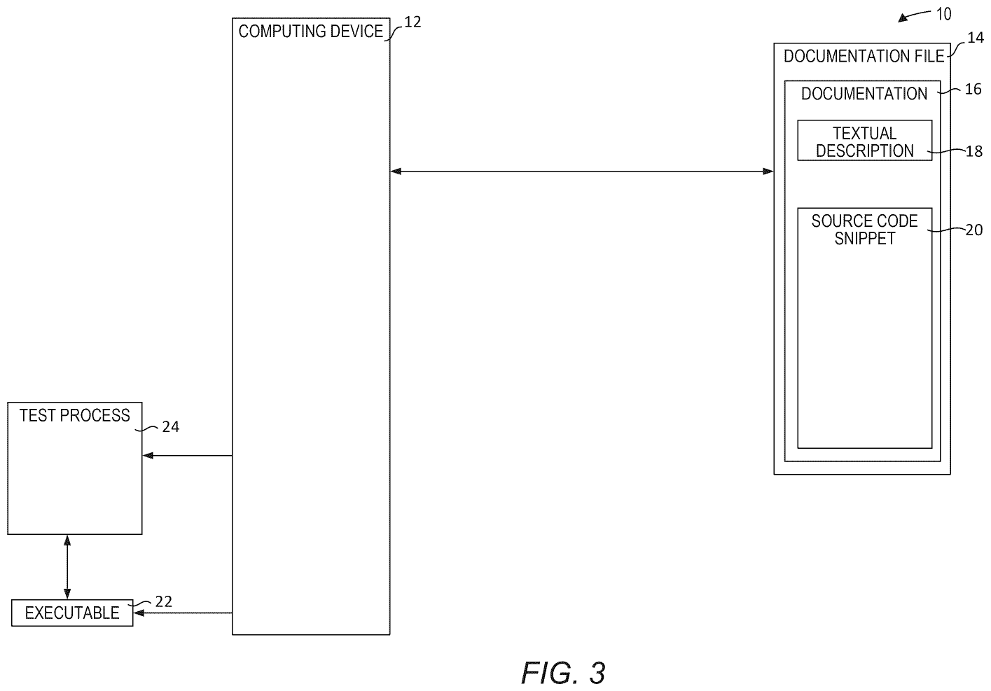

FIG. 3 is a block diagram of a computing system suitable for implementing validation of code snippets according to one example. The computing system 10 may comprise one or more computing devices 12. A computing device 12 can access a documentation file 14 having documentation 16 comprising a textual description 18 and a source code snippet 20. The computing device 12 can identify the source code snippet 20 and generate an executable 22 based on the source code snippet 20. The computing device 12 can execute a test process 24 using the executable 22. The test process 24 can cause an event, and the computing device 12 can determine whether the event is a valid or invalid event.

In some implementations, the parts depicted in FIG. 3 can be, comprise, be comprised by, share similar (e.g., same) properties or operate in a manner similar to (e.g., same as) one or more examples set forth in the description of FIG. 1 with respect to parts sharing a similar (e.g., same) name and part number.

FIG. 4 is a block diagram of a computing device suitable for implementing validation of code snippets according to one example. The computing device 430 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 430 includes the processor device 432, the system memory 450, and a system bus 446. The system bus 446 provides an interface for system components including, but not limited to, the system memory 450 and the processor device 432. The processor device 432 can be any commercially available or proprietary processor.

The system bus 446 may be any of several types of bus structures that may further interconnect to a memory bus (with or without a memory controller), a peripheral bus, and/or a local bus using any of a variety of commercially available bus architectures. The system memory 450 may include non-volatile memory 450-2 (e.g., read-only memory (ROM), erasable programmable read-only memory (EPROM), electrically erasable programmable read-only memory (EEPROM), etc.), and volatile memory 450-1 (e.g., random-access memory (RAM)). A basic input/output system (BIOS) 466 may be stored in the non-volatile memory 450-2 and can include the basic routines that help to transfer information between elements within the computing device 430. The volatile memory 450-1 may also include a high-speed RAM, such as static RAM, for caching data.

The computing device 430 may further include or be coupled to a non-transitory computer-readable storage medium such as the storage device 454, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 454 and other drives associated with computer-readable media and computer-usable media may provide non-volatile storage of data, data structures, computer-executable instructions, and the like.

A number of modules can be stored in the storage device 454 and in the volatile memory 450-1, including an operating system 456 and one or more program modules, such as the snippet testing module 464 which may implement the functionality described herein in whole or in part. All or a portion of the examples may be implemented as a computer program product 458 stored on a transitory or non-transitory computer-usable or computer-readable storage medium, such as the storage device 454, which includes complex programming instructions, such as complex computer-readable program code, to cause the processor device 432 to carry out the steps described herein. Thus, the computer-readable program code can comprise software instructions for implementing the functionality of the examples described herein when executed on the processor device 432. The processor device 432 may serve as a controller, or control system, for the computing device 430 that is to implement the functionality described herein.

An operator, such as a user, may also be able to enter one or more configuration commands through a keyboard (not illustrated), a pointing device such as a mouse (not illustrated), or a touch-sensitive surface such as a display device. Such input devices may be connected to the processor device 432 through an input device interface 460 that is coupled to the system bus 446 but can be connected by other interfaces such as a parallel port, an Institute of Electrical and Electronic Engineers (IEEE) 1394 serial port, a Universal Serial Bus (USB) port, an IR interface, and the like. The computing device 430 may also include the communications interface 462 suitable for communicating with a network (e.g., internet, wide area network, local area network, etc.) as appropriate or desired. The computing device 430 may also include a video port to interface with the display device 412, to provide information to a user.

Individuals will recognize improvements and modifications to the preferred examples of the disclosure. All such improvements and modifications are considered within the scope of the concepts disclosed herein and the claims that follow.

What is claimed is:

1. A method, comprising:
accessing, by a computing system comprising one or more computing devices, a file comprising documentation that includes a textual description and a source code snippet written to comply with a programming language syntax;
identifying, by the computing system, the source code snippet;
generating, by the computing system, an executable based on the source code snippet;
initiating, by the computing system, a test process that accesses the executable, the test process causing the executable to cause an event; and
determining, by the computing system, that the event is a valid event or an invalid event.

2. The method of claim 1, wherein generating an executable comprises:
determining, by the computing system based on the source code snippet, a programming language in which the source code snippet was written;
determining, by the computing system based on the programming language, additional source code defining an executable entry point;
adding, by the computing system, the additional source code to the source code snippet to generate combined source code; and
causing, by the computing system, the combined source code to be compiled into the executable.

3. The method of claim 2, wherein determining the additional source code comprises:
accessing, by the computing system, a data structure correlating a plurality of programming languages to a plurality of predetermined source code templates for defining an executable entry point; and
identifying, by the computing system based on the data structure, a predetermined source code template of the plurality of predetermined source code templates, the predetermined source code template being associated with the programming language in which the source code snippet was written.

4. The method of claim 2, wherein determining the programming language in which the source code snippet was written comprises:
accessing, by the computing system, a data structure correlating a plurality of respective source code patterns to a plurality of respective programming languages;
identifying, by the computing system, in the source code snippet, a source code pattern of the plurality of respective source code patterns; and
determining, based on the identified source code pattern and the data structure, the programming language in which the source code snippet was written.

5. The method of claim 4, wherein the identified source code pattern is associated with a syntax of the programming language in which the source code snippet was written.

6. The method of claim 4, wherein the identified source code pattern comprises a reference to a dependency associated with the programming language in which the source code snippet was written.

7. The method of claim 4, wherein the data structure comprises a plurality of regular expressions associated respectively with a plurality of programming languages.

8. The method of claim 2, further comprising:
determining, by the computing system based on the source code snippet, a programming language version of a plurality of programming language versions, wherein the programming language version is a version of the programming language in which the source code snippet was written; and
determining, by the computing system based on the programming language version, a compiler for compiling the combined source code according to the programming language version;
wherein the combined source code is compiled using the compiler.

9. The method of claim 1, wherein the executable is a first executable, and initiating the test process comprises:
initiating, by the computing system, a first computing process for running the first executable;
initiating, by the computing system, a second computing process for running a second executable different from the first executable;
causing, by the computing system, an error associated with the first computing process; and
determining, by the computing system, whether the error interferes with the second computing process.

10. The method of claim 9, wherein causing an error associated with the first computing process comprises:
identifying, by the computing system based at least in part on the source code snippet, an input parameter associated with the executable;
determining, by the computing system based at least in part on the source code snippet, an invalid input value for the input parameter; and
providing, by the computing system to the first computing process, the invalid input value as input.

11. The method of claim 9, wherein causing an error associated with the first computing process comprises:
identifying, by the computing system based at least in part on the source code snippet, a dependency associated with the first executable;
providing, by the computing system, a computing environment that lacks the dependency; and
initiating, by the computing system, the first computing process in the computing environment that lacks the dependency.

12. The method of claim 9, wherein the first computing process is initiated on a first computing device, and the second computing process is initiated on the first computing device.

13. The method of claim 12, wherein the second computing process comprises a container.

14. The method of claim 1, comprising:
determining, by the computing system based on the source code snippet, a plurality of code paths associated with the source code snippet;
initiating, by the computing system, a plurality of respective test processes that access the executable, each respective test process causing the executable to follow a respective code path of the plurality of code paths, and each respective test process causing the executable to cause a respective event; and
determining, by the computing system for each respective event, that the respective event is a valid event or an invalid event.

15. The method of claim 1, wherein initiating a test process that accesses the executable comprises:
identifying, by the computing system based on the file comprising documentation, a dependency associated with the source code snippet;
generating, by the computing system, a container image comprising the dependency;
initiating, by the computing system based on the container image, a container; and
running, in the container, the executable.

16. The method of claim 1, wherein the documentation comprises markup language, and identifying the source code snippet comprises:
identifying, by the computing system, a markup component indicative of a source code block; and
identifying, based on the markup component, the source code snippet.

17. The method of claim 1, wherein generating an executable comprises:
identifying, by the computing system, a syntax error in the source code snippet;
determining, by the computing system, a correction for the syntax error; and
modifying, by the computing system based on the correction, the source code snippet.

18. The method of claim 1, wherein determining that the event is a valid event or an invalid event comprises:
obtaining, by the computing system, one or more requirements associated with a safety integrity level; and
comparing, by the computing system, the event to the one or more requirements.

19. A computing system comprising:
one or more computing devices to:
access a file comprising documentation that includes a textual description and a source code snippet written to comply with a programming language syntax;
identify the source code snippet;
generate an executable based on the source code snippet;
initiate a test process that accesses the executable, the test process causing the executable to cause an event; and
determine that the event is a valid event or an invalid event.

20. A non-transitory computer-readable storage medium that includes executable instructions to cause one or more processor devices to:
access a file comprising documentation that includes a textual description and a source code snippet written to comply with a programming language syntax;
identify the source code snippet;
generate an executable based on the source code snippet;
initiate a test process that accesses the executable, the test process causing the executable to cause an event; and
determine that the event is a valid event or an invalid event.
